(19) United States
(12) Patent Application Publication
(10) Pub. No.: US 2009/0122256 A1
(43) Pub. Date: May 14, 2009

(54) EYEGLASSES WITH ADJUSTABLE TEMPLES

(76) Inventor: Ching-Yung Wu, Tainan Hsien (TW)

Correspondence Address: MCNEES WALLACE & NURICK LLC, 100 PINE STREET, P.O. BOX 1166, HARRISBURG, PA, 17108-1166, US

(21) Appl. No.: 12/013,880

(22) Filed: Jan. 14, 2008

(30) Foreign Application Priority Data
Nov. 9, 2007 (TW) 096218934

(51) Int. Cl. G02C 5/22

(52) U.S. Cl. 351/120

(57) ABSTRACT

Eyeglasses include a lens unit that has opposite end portions, and a pair of temples respectively disposed on the end portions of the lens unit. The lens unit is formed with an aperture and a positioning hole in each of the end portions. The positioning hole is defined by a hole-defining wall. Each temple includes a pivot unit pivotally disposed on the respective one of the end portions. The pivot unit of each of the temples includes a pivot shaft rotatably engaged with the aperture in the respective one of the end portions so as to permit rotation of the pivot unit relative to the lens unit about an axis of the pivot shaft, and a protrusion releasably engaging the hole-defining wall of the positioning hole in the respective one of the end portions.

### BACKGROUND OF THE INVENTION

1. Field of the Invention

This invention relates to eyeglasses, more particularly to eyeglasses with adjustable temples.

2. Description of the Related Art

Ergonomics in eyeglass design has increasingly become an important buying consideration for some consumers in recent years. An example of an ergonomic design for eyeglasses includes that in which the eyeglasses are equipped with adjustable temples, that is, the temples can be vertically adjusted relative to the frame so that the eyeglasses can be positioned desirably on a wearer's face and can be comfortably worn by the wearer. However, consumers are limited to only a few selections of such eyeglasses with adjustable temples, and the different designs that are available are virtually identical in their adjusting structure.

### SUMMARY OF THE INVENTION

Therefore, it is an object of the present invention to provide eyeglasses with adjustable temples that utilize a new adjusting structure.

The eyeglasses of this invention include a lens unit that has opposite end portions, and a pair of temples respectively disposed on the end portions of the lens unit. The lens unit is formed with an aperture and a positioning hole in each of the end portions of the lens unit. The positioning hole is defined by a hole-defining wall. Each temple includes a pivot unit pivotally disposed on the respective one of the end portions of the lens unit. The pivot unit of each of the temples includes a pivot shaft rotatably engaged with the aperture in the respective one of the end portions so as to permit rotation of the pivot unit relative to the lens unit about an axis of the pivot shaft, and a protrusion extending into the positioning hole in the respective one of the end portions and releasably engaging the hole-defining wall of the positioning hole in the respective one of the end portions.

### BRIEF DESCRIPTION OF THE DRAWINGS

Other features and advantages of the present invention will become apparent in the following detailed description of the preferred embodiment with reference to the accompanying drawings, of which:

FIG. 1 is a partly exploded perspective view of the preferred embodiment of a pair of eyeglasses according to the present invention;

FIG. 2 is an enlarged fragmentary, exploded perspective view of the preferred embodiment;

FIG. 3 is an enlarged fragmentary perspective view of the preferred embodiment, illustrating a temple and an end portion of a lens unit in an assembled state;

FIG. 4 is a view similar to FIG. 3, but with part of a first lock member removed to better illustrate engagement between a protrusion and a hole-defining wall;

FIG. 5 is a sectional view of the preferred embodiment; and

FIG. 6 is a schematic view of the preferred embodiment, illustrating fully the temple and the end portion of FIG. 3.

### DETAILED DESCRIPTION OF THE PREFERRED EMBODIMENT

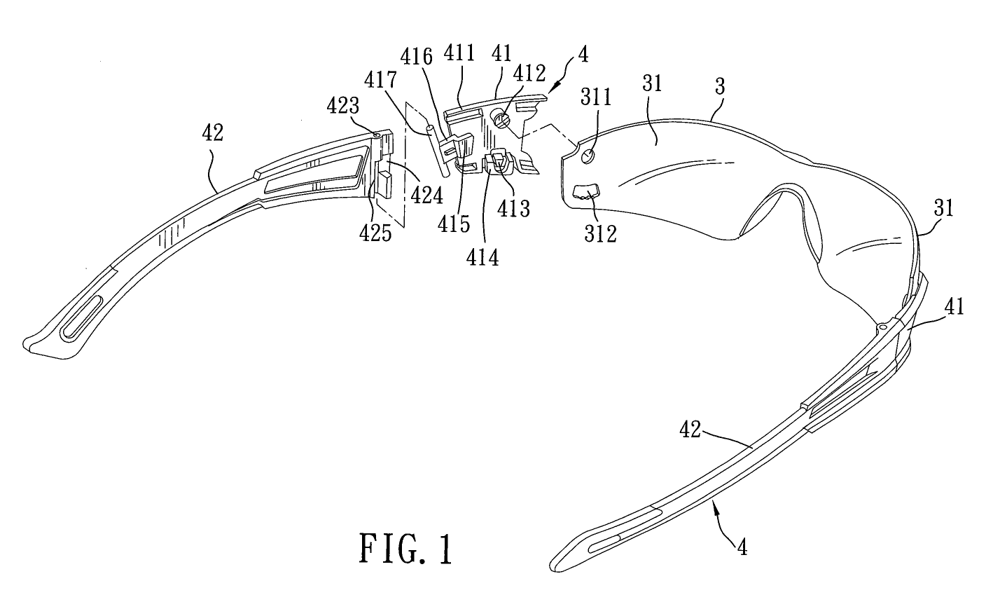

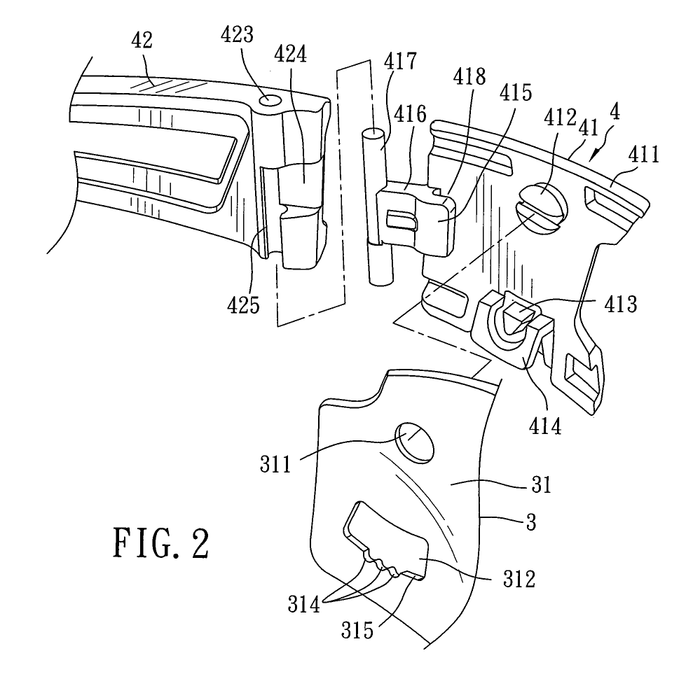

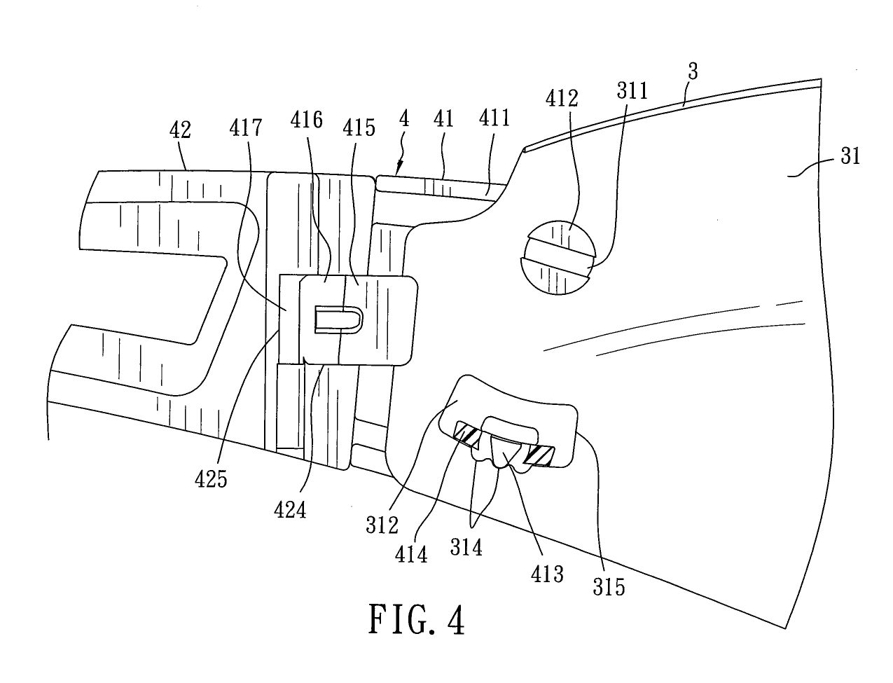

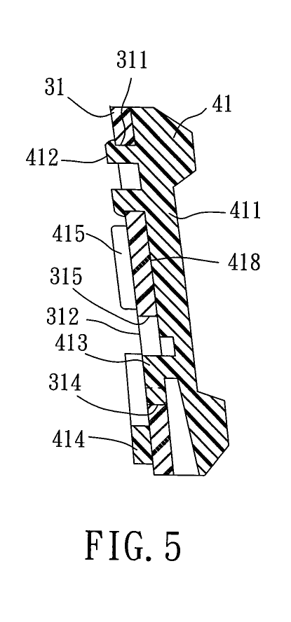

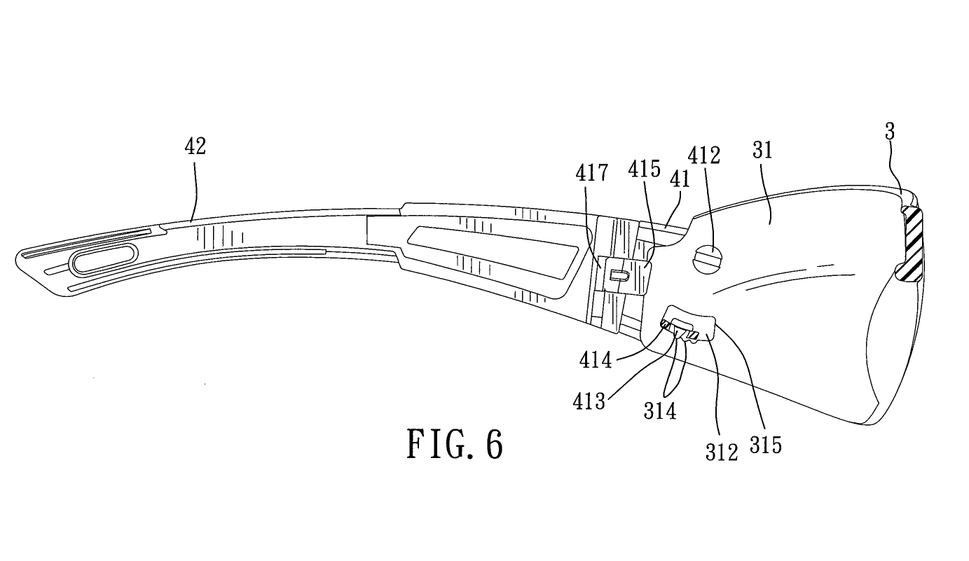

The preferred embodiment of a pair of eyeglasses with adjustable temples of the present invention is illustrated in FIGS. 1 to 6. The eyeglasses include a lens unit 3 that has opposite end portions 31, and a pair of temples 4 respectively disposed on the end portions 31 of the lens unit 3. In the preferred embodiment, each of the end portions 31 of the lens unit 3 curves rearwardly. The lens unit 3 is formed with an aperture 311 and a positioning hole 312 in each of the end portions 31. The positioning hole 312 is defined by a hole-defining wall 315.

Each temple 4 includes a pivot unit 41 pivotally disposed on the respective one of the end portions 31. The pivot unit 41 of each of the temples 4 includes a pivot shaft 412 rotatably engaged with the aperture 311 in the respective one of the end portions 31 so as to permit rotation of the pivot unit 41 relative to the lens unit 3 about an axis of the pivot shaft 412, and a protrusion 413 extending into the positioning hole in the respective one of the end portions and releasably engaging the hole-defining wall 315 of the positioning hole 312 in the respective one of the end portions 31. In the preferred embodiment, each pivot shaft 412 is shaped in the form of a pair of spaced-apart and resilient protruding parts, each with a distal end that is semi-circular.

In the preferred embodiment, the hole-defining wall 315 that defines the positioning hole 312 in the corresponding end portion 31 of the lens unit 3 is formed with a plurality of spaced-apart notches 314 to a selected one of which the protrusion 413 of the pivot unit 41 of the respective one of the temples 4 is releasably engaged. Also, in the preferred embodiment, the aperture 311 and the positioning hole 312 in each of the end portions 31 of the lens unit 3 are vertically spaced apart, and the notches 314 are formed in a lower portion of the hole-defining wall 315 of the positioning hole 312.

In some embodiments, the hole-defining walls 315 are smooth and the notches 314 are not formed therein. With such a configuration, adjustment of the temples 4 is realized in a stepless manner, which is realized purely through frictional engagement between the protrusions 413 and the hole-defining walls 315. Each temple 4 further includes a temple bar 42 pivotally disposed on the pivot unit 41 such that the temple bar 42 is foldable toward and unfolded away from the lens unit 3.

In the preferred embodiment, the pivot unit 41 of each temple 4 includes an abutment plate 411 abutting against an outer surface of the respective one of the end portions 31 of the lens unit 3 and from which the pivot shaft 412 and the protrusion 413 of the pivot unit 41 extend, and a first lock member 414 extending from the abutment plate 411 through the positioning hole 312 in the respective one of the end portions 31 of the lens unit 3 and abutting against an inner surface of the lens unit 3. For the pivot unit 41 of each temple 4, the first lock member 414 partly surrounds a periphery of the protrusion 413. With this configuration, the protrusion 413 and the first lock member 414 of the pivot unit 41 may be moved together in the one of the positioning holes 312 and thereby be rotatable about the pivot shaft 412. In addition, in the preferred embodiment, the pivot unit 41 of each temple 4 further includes a second lock member 415 that protrudes forwardly from a rear portion of the abutment plate 411 thereof and that abuts resiliently against the lens unit 3. The second lock member 415 defines a recess 418 with the abutment plate 411 for receiving a part of the respective one of the end portions 31 of the lens unit 3.

In the preferred embodiment, the temple bar 42 of each temple 4 has a front end that is pivotally disposed on the pivot unit 41 such that the temple bar 42 is foldable toward and unfoldable away from the lens unit 3. The temple bar 42, in the preferred embodiment, is formed with a longitudinal pivot hole 423 that extends vertically through the front end of the temple bar 42. Also, in the preferred embodiment, the pivot unit 41 of each temple 4 further includes a pivot pin 417 that rotatably and detachably extends into the pivot hole 423 in the temple bar 42, and a link member 416 that interconnects the pivot pin 417 and the abutment plate 411. In the preferred embodiment, the temple bar 42 of each temple 4 is further formed with an opening 425 in the front end thereof that exposes a lower section of the pivot hole 423 thereof. The link member 416 extends through the opening 425 in the temple bar 42. Further, in the preferred embodiment, a limiting recess 424 is formed in a front, inner face of the temple bar 42 that is in spatial communication with the lower half section of the pivot hole 423.

To assemble the eyeglasses of the preferred embodiment, the temple bar 42 and the pivot unit 41 of one of the temples 4 are first brought together forming an angle of 90 degrees therebetween and with the temple bar 42 positioned above the pivot pin 417. The pivot pin 417 of the pivot unit 41 is then upwardly inserted in the pivot hole 423 such that the link member 416 is also concomitantly moved upwardly along the opening 425. This is continued until the link member 416 is aligned with the limiting recess 424 to thereby complete assembly. In this state, the temple bar 42 is rotatable about the pivot pin 417 in such a way that it can be folded onto and unfolded away from the lens unit 3. The other temple 4 is coupled to the lens unit 3 in a similar manner to thereby complete assembly of the eyeglasses.

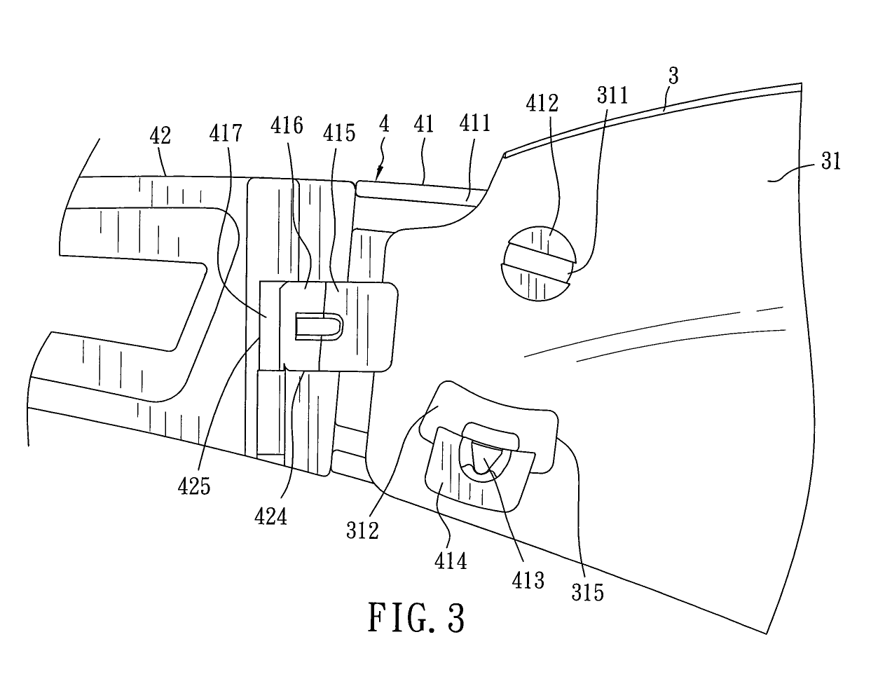

With reference to FIGS. 3, 4, and 6, when it is desired to adjust one of the temples 4 vertically relative to the lens unit 3, the temple bar 42 of the temple 4 is manipulated by a wearer to pivot upwardly or downwardly such that the pivot unit 41 of the temple 4 pivots about the stationary axis of the pivot shaft 412. As such, the protrusion 413 is moved inside the positioning hole 312 of the respective one of the end portions 31 and is received in a selected one of the notches 314 of the hole-defining wall 315 of the respective one of the end portions 31. During this adjustment, the protrusion 413 is slightly and resiliently deformed so as to allow for movement thereof to an adjacent one of the notches 314.

In the preferred embodiment, the first and second lock members 414, 415 cooperate with the abutment plates 411 to clamp the pivot units 41 of the temples 4 onto the end portions 31 of the lens unit 3. However, in some embodiments, the first and second lock members 414, 415 may be omitted from the configuration, in which case such pivotable engagement between the pivot unit 41 of each of the temples 4 and the lens unit 3 is realized through the interaction among the pivot shaft 412 and the protrusion 413 with the aperture 311 and the positioning hole 312 of the respective one of the end portions 31 of the lens unit 3. Moreover, in some embodiments, the pivot units 41 may be formed as a single piece respectively with the temple bars 42, in which case the temple bars 42 are unable to rotate relative to the pivot units 41.

Furthermore, in the preferred embodiment, the aperture 311 and the positioning hole 312 in each of the end portions 31 of the lens unit 3 are vertically arranged as described above, and the pivot shaft 412 and the protrusion 413 of the pivot unit 41 of each of temples 4 are also vertically arranged. However, in some embodiments, the aperture 311 and the positioning hole 312 in each of the end portions 31, as well as the pivot shaft 412 and the protrusion 413 of each of the pivot unit 41 of each of the temples 4, can be horizontally arranged or arranged in any other orientation. With such alternative orientations, the same pivoting mechanism as described hereinabove may likewise be realized.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. Eyeglasses comprising:
a lens unit having opposite end portions, and formed with an aperture and a positioning hole in each of said end portions, said positioning hole being defined by a hole-defining wall; and
a pair of temples respectively disposed on said end portions of said lens unit, each of said temples including a pivot unit pivotally disposed on the respective one of said end portions, said pivot unit of each of said temples including a pivot shaft rotatably engaged with said aperture in the respective one of said end portions so as to permit rotation of said pivot unit relative to said lens unit about an axis of said pivot shaft, and a protrusion that extends into said positioning hole in the respective one of said end portions and that releasably engages said hole-defining wall of said positioning hole in the respective one of said end portions.

2. The eyeglasses as claimed in claim 1, wherein said hole-defining wall is formed with a plurality of spaced-apart notches to a selected one of which said protrusion of said pivot unit of the respective one of said temples is releasably engaged.

3. The eyeglasses as claimed in claim 2, wherein said aperture and said positioning hole in each of said end portions of said lens unit are vertically spaced apart, and said notches are formed in a lower portion of said hole-defining wall of said positioning hole.

4. The eyeglasses as claimed in claim 3, wherein each of said temples further includes a temple bar pivotally disposed on said pivot unit such that said temple bar is foldable toward and unfoldable away from said lens unit.

5. The eyeglasses as claimed in claim 1, wherein said pivot unit of each of said temples further includes an abutment plate abutting against an outer surface of the respective one of said end portions of said lens unit, and a first lock member extending from said abutment plate through said positioning hole in the respective one of said end portions of said lens unit and abutting against an inner surface of said lens unit.

6. The eyeglasses as claimed in claim 5, wherein said pivot unit of each of said temples further includes a second lock member protruding forwardly from a rear portion of said abutment plate and abutting resiliently against said lens unit, said second lock member defining a recess with said abutment plate for receiving a part of the respective one of said end portions of said lens unit.

7. The eyeglasses as claimed in claim 5, wherein each of said temples further includes a temple bar having a front end, said temple bar being pivotally disposed on said pivot unit such that said temple bar is foldable toward and unfoldable away from said lens unit, said temple bar being formed with a longitudinal pivot hole that extends vertically through said front end of said temple bar,
wherein said pivot unit of each of said temples further includes a pivot pin that rotatably and detachably extends into said pivot hole in said temple bar, and a link member that interconnects said pivot pin and said abutment plate, and wherein said temple bar is further formed with an opening in said front end of said temple bar that exposes a lower section of said pivot hole, said link member extending through said opening.
